(19) United States
(12) Patent Application Publication
(10) Pub. No.: US 2010/0257101 A1
(43) Pub. Date: Oct. 7, 2010

(54) SECURE STRING-BASED TRANSACTION SYSTEM AND METHOD

(76) Inventor: Luis Fierro, Tialnepantia (MX)

Correspondence Address: Luis Fierro Acosta, Colima 214, Colonia Jacarandas, Tialnepantia, 54050, M

(21) Appl. No.: 12/753,451

(22) Filed: Apr. 2, 2010

Related U.S. Application Data
(60) Provisional application No. 61/166,548, filed on Apr. 3, 2009.

(51) Int. Cl. G06Q 20/00

(52) U.S. Cl. 705/64

(57) ABSTRACT

A secure string-based transaction system and method is disclosed which includes one or more client devices (e.g., a customer device, a merchant device) connected in association with a transaction server via a communication network. An encryption device having a microcontroller can be configured in association with each client device to encrypt, decrypt and validate transaction data strings transmitted and received via the client device. A transaction service application associated with the transaction server can be employed to encrypt, decrypt and validate the transaction data strings in order to provide a comprehensively secure transaction. The data associated with a payment process can be stored in a database and the encryption device can retain random data from previous transaction to prevent cloning of the device.

### CROSS-REFERENCE TO PROVISIONAL PATENT APPLICATION

This patent application claims priority to and the benefit under 35 U.S.C. §119(e) of U.S. Provisional Patent Application Ser. No. 61/166,548, filed on Apr. 3, 2009, the disclosure of which is incorporated herein by reference.

### TECHNICAL FIELD

Embodiments are generally related to secure communications systems and techniques. Embodiments also relate to the field of computers and similar technologies, and in particular to software utilized in this field. Embodiments are additionally related to methods and systems for providing a secure transaction over a communication network.

### BACKGROUND OF THE INVENTION

With the advent of Internet, electronic commerce (e-commerce) has become an emerging trend for varying business transaction applications. Such Internet-based business transaction applications are generally configured to draw together a wide range of business and trade support services for commodities, products and custom built goods and services. Such a transaction application can be widely accustomed by a customer/merchant for purchasing/selling a product online. For example, a customer can access a merchant website hosted on a server in order to select an item for purchase and make respective payment for the selected item on the merchant website utilizing a credit card. To transact business over the Internet, companies or individuals must have an efficient, reliable and secured manner to conduct private communications there between.

The majority of prior art approaches for providing a secure transaction employ encryption for the secured transaction of information over the Internet. Such prior art approaches can encrypt the transaction information and upload or download the encrypted data via a background transfer process. Such background transfer processes can be widely affected by varying spyware/malware applications such as, for example, Trojan horse programs, key loggers and other spoofing techniques, which facilitate hacking and fraudulent transactions and virus transfers over a network, such as the Internet. Furthermore, in most prior art approaches, the client device is not configured with a secure means for protecting the transaction information at the client end. Such malicious applications can therefore easily affect the client (e.g., customer/merchant) device resulting in monetary losses to financial institutions and business customers.

Based on the foregoing, it is believed that a need exists for an improved system and method for providing a secure transaction over a communication network as will be discussed in greater detail herein.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved secure transaction system and method.

It is another aspect of the disclosed embodiments to provide for an improved string based encryption algorithm, which can be utilized secure electronic financial and data transactions over a computer network, such as the Internet.

It is a further aspect of the disclosed embodiments to provide for an improved string-based transaction system and method for providing a secure transaction over a communications network.

The aforementioned aspects and other objectives and advantages can now be achieved as described herein. A secure string-based transaction system and method is disclosed herein. One or more client devices (e.g., a customer device and a merchant device) can be connected in association with a transaction server via a communication network (e.g., an Internet). An encryption device (e.g., USB device) having a microcontroller can be configured in association with each client device to encrypt, decrypt and validate transaction data strings transmitted and received via the client device. A transaction service application associated with the transaction server can be employed to encrypt, decrypt and validate the transaction data strings in order to provide a comprehensively secure transaction. The client device can act as an interface to transmit and receive transaction data strings via the communication network. The data associated with a payment process can be stored in a database and the encryption device can retain previous transaction information as random data to prevent cloning of the device.

In one embodiment, independent USB devices can be employed by a customer and a merchant in order to perform an on-line purchase. The USB device associated with the customer device receives and encrypts the transaction data strings provided by the customer and transmits the data to the merchant device and the transaction server via the network. The USB device associated with the merchant device receives and encrypts the transaction data strings provided by a merchant and transmits to the customer device and the server via the network. The transaction server decrypts and validates the transaction data strings from the customer device and the merchant device and provide a validated encrypted data string for approval. The USB device associated with the customer device and the merchant device can further decrypt and validate the data strings received from the server and provide a confirmation string to the server. The server can receive such confirmation data string, validate and approve the transaction and provide a receipt of confirmation.

The merchant program associated with the merchant device can also perform the task required for the customer and the merchant. The customer can input the password via a keypad provided by the merchant. The data required by the customer USB device can be transmitted via the merchant device in such a way that the customer can verify, the merchant's ID and the total amount to be paid in the USB device. The data required by the customer USB device can be also transmitted via a terminal which can be employed as an interface between the merchant device and the USB device. The customer can input the password via the integrated terminal's keypad. In another embodiment, the customer can directly access the server via the USB device associated with the customer device and a web browser in order to perform a secured financial transaction over the network.

The USB device includes a firmware application that encrypts and decrypts the transaction data strings associated with client devices and a USB interface for interfacing the client device. The USB device further includes a display, a select button and an enter button to display the transaction strings that are transmitted/received by the client device. The encrypted data string includes ASCII decimal value (range preferably between 32 and 126) and forbids the use of control characters for the generated encrypted strings. The client devices can receive the receipt of such transaction confirmation via the USB device or an e-mail message. Such secure string-based transaction system and method can be effectively utilized in varying web-based transaction applications such as, e-banking and on-line business transactions in order to provide secured transactions between the clients.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the disclosed embodiments.

FIG. 1 illustrates a schematic view of a data-processing system in which an embodiment may be implemented;

FIG. 2 illustrates a schematic view of a software system including an operating system, application software, and a user interface for carrying out an embodiment;

FIG. 3 illustrates a graphical representation of a secure string-based transaction system, in accordance with the disclosed embodiments;

FIG. 4 illustrates a block diagram of a transaction server, in accordance with the disclosed embodiments;

FIG. 5 illustrates a high level flow chart of operation illustrating logical operational steps of a method for accomplishing a payment transaction with respect to a customer device, in accordance with the disclosed embodiments;

FIG. 6 illustrates a high level flow chart of operation illustrating logical operational steps of a method for accomplishing a payment transaction with respect to a merchant device, in accordance with the disclosed embodiments;

FIG. 7 illustrates a detailed flow chart of operation illustrating logical operational steps of a method for accomplishing a payment order with respect to the secure string-based transaction system, in accordance with the disclosed embodiments;

FIG. 8 illustrates a detailed flow chart of operation illustrating logical operational steps of a method for accomplishing a purchase order with respect to the secure string-based transaction system, in accordance with the disclosed embodiments;

FIG. 9 illustrates a detailed flow chart of operation illustrating logical operational steps of a method for accomplishing a payment confirmation with respect to the secure string-based transaction system, in accordance with the disclosed embodiments;

FIG. 10 illustrates a graphical representation of the secure string-based transaction system associated with a keypad provided by a merchant, in accordance with the disclosed embodiments;

FIG. 11 illustrates a graphical representation of the secure string-based transaction system associated with a terminal for communicating a customer USB device, in accordance with the disclosed embodiments;

FIG. 12 illustrates a graphical representation of a secure string-based transaction system that is utilized in context of a financial institution, in accordance with the disclosed embodiments;

FIG. 13 illustrates a block diagram of a financial transaction server, in accordance with the disclosed embodiments;

FIG. 14 illustrates a high level flow chart of operation illustrating logical operation steps of a method for accomplishing an account to account transaction with respect to the customer device, in accordance with the disclosed embodiments;

FIG. 15 illustrates a high level flow chart of operation illustrating logical operation steps of a method for accomplishing an account-to-account transaction with respect to the financial transaction server, in accordance with the disclosed embodiments; and

FIG. 16 illustrates a detailed flow chart of operation illustrating logical operation steps of a method for providing an account-to-account transaction in context of the financial institution, in accordance with the disclosed embodiments.

### DETAILED DESCRIPTION

The particular values and configurations discussed in these non-limiting examples can be varied and are cited merely to illustrate varying embodiments and are not intended to limit the scope thereof.

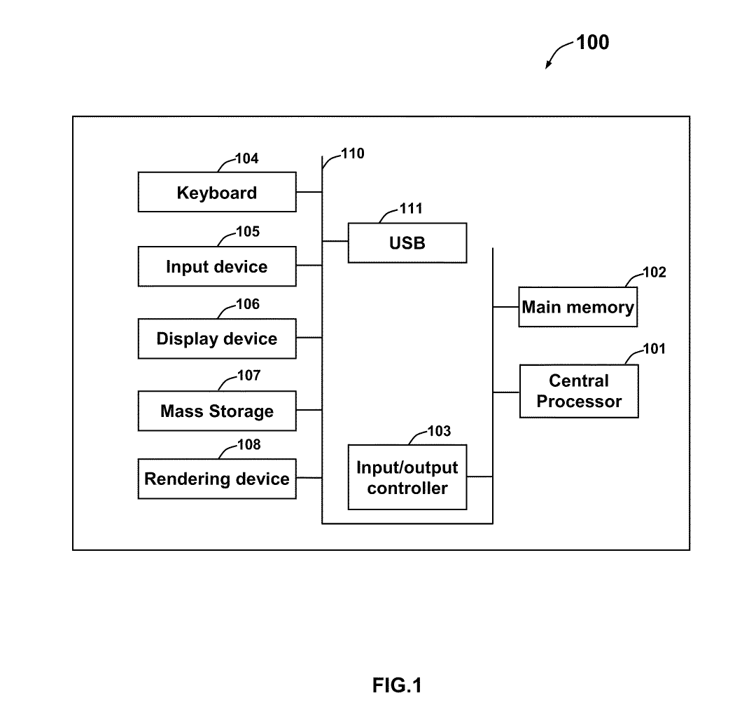

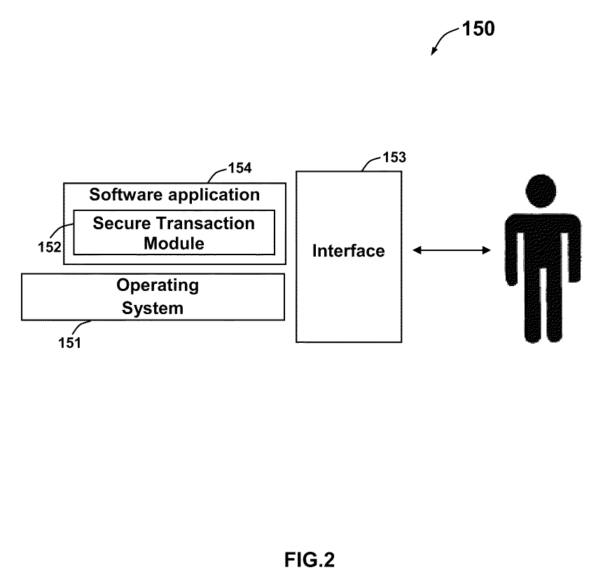

FIGS. 1-2 are provided as exemplary diagrams of data-processing environments in which embodiments of the present invention may be implemented. It should be appreciated that FIGS. 1-2 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 1, the disclosed embodiments may be implemented in the context of a data-processing system 100 that includes, for example, a central processor 101, a main memory 102, an input/output controller 103, a keyboard 104, an input device 105 (e.g., a pointing device, such as a mouse, track ball, pen device, etc), a display device 106, a mass storage 107 (e.g., a hard disk), and a USB (Universal Serial Bus) peripheral connection 111. Additional input/output devices, such as a rendering device 108 (e.g., printer, scanner, fax machine, etc), for example, may be associated with the data-processing system 100 as desired. As illustrated, the various components of data-processing system 100 can communicate electronically through a system bus 110 or similar architecture. The system bus 110 may be, for example, a subsystem that transfers data between, for example, computer components within data-processing system 100 or to and from other data-processing devices, components, computers, etc.

FIG. 2 illustrates a computer software system 150 for directing the operation of the data-processing system 100 depicted in FIG. 1. Software application 154, stored in main memory 102 and on mass storage 107, generally includes a kernel or operating system 151 and a shell or interface 153. One or more application programs, such as software application 154, may be “loaded” (i.e., transferred from mass storage 107 into the main memory 102) for execution by the data-processing system 100. The data-processing system 100 receives user commands and data through user interface 153; these inputs may then be acted upon by the data-processing system 100 in accordance with instructions from operating system module 151 and/or software application 154.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” constitutes a software application.

Generally, program modules include, but are not limited to routines, subroutines, software applications, programs, objects, components, data structures, etc., that perform particular tasks or implement particular abstract data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application, such as a computer program designed to assist in the performance of a specific task, such as word processing, accounting, inventory management, etc.

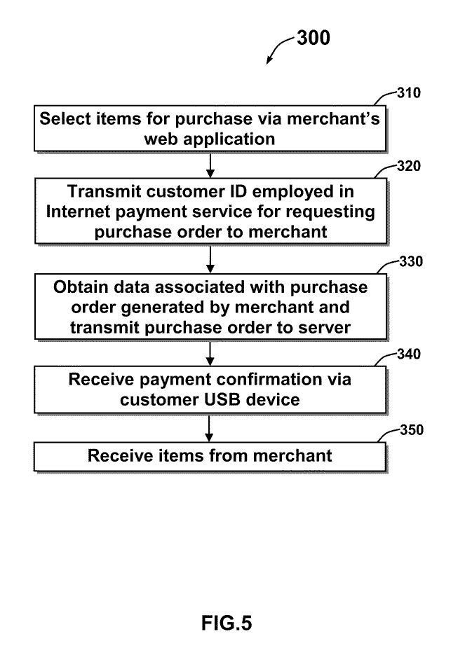

The interface 153, which is preferably a graphical user interface (GUI), can serve to display results, whereupon a user may supply additional inputs or terminate a particular session. In some embodiments, operating system 151 and interface 153 can be implemented in the context of a “Windows” system. It can be appreciated, of course, that other types of systems are potential. For example, rather than a traditional “Windows” system, other operation systems, such as, for example, Linux may also be employed with respect to operating system 151 and interface 153. The software application 154 can include, for example, a secure transaction module 152 for providing a secure string-based transaction. The secure transaction module 152 can include instructions, such as those of method 400 and 450 and 800 and 850 respectively discussed herein with respect to FIGS. 5-6 and FIGS. 14-15.

The following description is presented with respect to embodiments of the present invention, which can be embodied in the context of a data-processing system 100 depicted in FIG. 1. The present invention, however, is not limited to any particular application or any particular environment. Instead, those skilled in the art will find that the system and methods of the present invention can be advantageously applied to a variety of system and application software, including database management systems, word processors, and the like. Moreover, the present invention can be embodied on a variety of different platforms, including Macintosh, UNIX, LINUX, and the like. Therefore, the description of the exemplary embodiments, which follows, is for purposes of illustration and not considered a limitation.

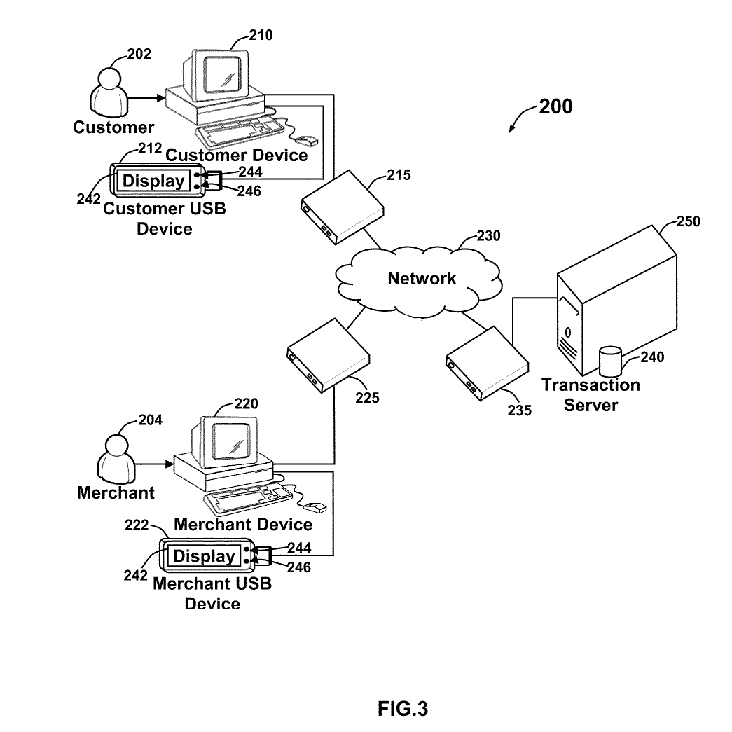

FIG. 3 illustrates a graphical representation of a secure string-based transaction system 200 utilized in context of an on-line business transaction application, in accordance with the disclosed embodiments. Note that in FIGS. 1-16, identical or similar blocks are generally indicated by identical reference numerals. The system 200 generally includes one or more client devices such as, for example, a customer device 210, a merchant device 220 connected to a transaction server 250 via a communication network 230 to provide secure transactions between the client devices 210 and 220. The system 200 can be employed to communicate transaction data strings associated with one or more clients such as, a customer 202 and a merchant 204 over the network 230. Note that the customer 202 may be any user, such as private persons or companies accessing the customer device 210 with a desire to purchase one or more items from the merchant 204. Similarly, the merchant 204 may be any vendor offering the items for sale on the communication network 230.

Network 230 may employ any network topology, transmission medium, or network protocol, such as, for example, Internet. Network 230 may include connections, such as wired links, wireless communication links, fiber optic cables, USB components, and so forth. The network 230 represents a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data-processing system 100 also may be implemented as a number of different types of networks, such as for example, an intranet, a local area network (LAN), or a wide area network (WAN). In the depicted example, server 250 connects to and communicates with the network 230 along with a storage unit 240 (e.g. a memory, database, etc). In addition, the client devices 210 and 220 connect to and communicate with the network 230.

The system 100 further includes modems such as, modems 215, 225 and 235 that can be employed to connect the devices 210, 220 and the sever 250 over the network 230. The customer device 210 can be a data-processing system 100 that is configured in association with a customer USB device 212 in order to encrypt/decrypt the transaction data strings transmitted/received by the customer device 210. Similarly, the merchant device 220 can be a data-processing system 100 configured in association with a merchant USB device 222 in order to encrypt/decrypt the transaction data strings transmitted/received by the merchant device 220 over the communication network 230. The USB device 212 and 222 can include a microcontroller having a firmware application that is capable of encrypting/decrypting and validating the transaction data strings transmitted/received by the customer and the merchant devices 210 and 220, respectively. The USB device 212 and 222 can further include a display 242, a select button 244 and an enter button 246 employed to display the transaction strings transmitted/received by the devices 210 and 220. The customer device 210 and merchant device 220 may be configured to communicate through the transaction server 250 in accordance with techniques such as, RF, BT, IrDA, VFIR or any of a number of different wired or wireless communication techniques, including serial, WiFi, LAN, Ethernet, WLAN, WiMax and/or UWB communication techniques.

The customer device 210 can include any standard network application, such as, for example Internet Explorer, Firefox or any other browser capable of displaying the merchant's webpage or e-shop. The items provided by the merchant 204 may be, for example, travel services, investment services, CD recordings, books, software, computer hardware and the like. The items can be offered for sale through the merchant's website. The merchant's website can be linked to the transaction server 250, so that transaction strings from the customer 202 can be directed to the transaction server 250. Note that the transaction data strings generally includes ASCII values associated with the transaction information such as, for example, customer ID, merchant ID, and an encryption key. Such transaction data strings can be encrypted/decrypted at the USB device 212 and 222 utilizing varying encryption and decryption techniques that are well known in the art.

The encrypted data string includes ASCII decimal value (range preferably between 32 and 126) and forbids the use of control characters for the generated encrypted strings. The length of the transaction data strings can be preferably in the range of 20 to 100 characters, and the total amount of data strings can be in the range of approximately 2 to 6 strings. The restricted range of ASCII decimal values serves as a malware filter. The transaction data strings can be transmitted or pasted on varying operating systems and programming languages. Such transaction data strings associated with the secure string-based transaction system 200 can be easily monitored with a firewall or pasted in the webpage or transmitted via an e-mail for communicating transaction information between the client devices 210 and 220.

The database 240 associated with the transaction server 250 stores the client data (e.g., encryption keys, users' IDs, user code and other data) associated with the client profile. The transaction data strings can be transmitted via ftp, winsock connection and so forth. The USB device 212 and 222 transmit encrypted transaction data strings to the transaction server 250 over the network 230. The USB device 212 and 222 display transmitted data strings, as well as receives decrypted string data as shown on the display. The customer device 210 and the merchant device 220 can act as an interface to transmit and receive the transaction data strings via the communication network 230. The transaction server 250 associated with the secure transaction application module 152 can encrypt/decrypt, validate and approve the transaction data strings utilizing the client data stored in a database 240 in order to provide a secured transaction over the network 230. The system 200 can therefore provide an improved transaction application that effectively secures transaction information from virus and hackers.

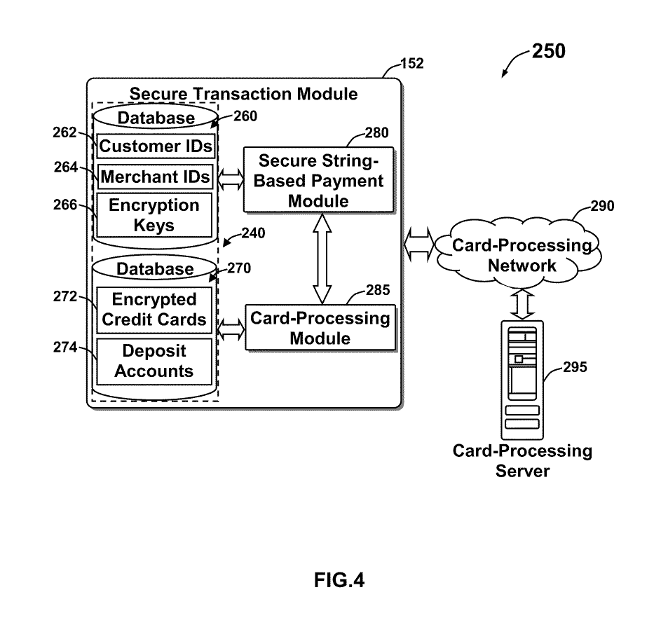

FIG. 4 illustrates a block diagram of the transaction server 250, in accordance with the disclosed embodiments. The secure transaction module 152 associated with the transaction server 250 can include a secure string-based payment module 280, a card-processing module 285 and a database 260 and 270. The secure transaction module 152 can provide Internet payment services between the customer 202 and the merchant 204 over the network 230. The transaction server 250 can receive transaction account information and personal information such as, name, address, telephone and fax and/or e-mail address with respect to the customer 202. The transaction information associated with the customer 202 can be securely stored in the database 260 and 270. There is no need for transmitting such information during purchase. The transaction information associated with the customer 202 can be transmitted to the transaction server 250 via conventional mail, e-mail or entered through a secure website (e.g preferably through a winsock connection). The customer 202 could concurrently view the merchant's 204 website with an alternate port using HTML.

The database 260 stores personal information such as, customer ID 262, merchant ID 264 and encryption keys 266 associated with the customer 202 and the merchant 204. The secure transaction module 280 can further access the database 260 in order to retrieve such information for validation associated with a purchase order. The database 270 stores the transaction account information such as, encrypted credit cards 272 and deposit accounts 274. The card-processing module 285 can further access the database 270 in order to retrieve the transaction account information contained in the database 270 for card-processing. The database 260 also stores previous transaction data strings as random data to prevent cloning of data on an encrypted transaction device, both for the customer device 210 and merchant device 220. The transaction server 250 can further access a card-processing server 295 via a card processing network 290 in order to authenticate and approve the transactions associated with the secure string-based transaction system 200. The transaction server 250 can therefore receive, encrypt/decrypt, validate and approve the encrypted strings from the customer device 210 and the merchant device 220 to provide comprehensively secured transaction.

FIG. 5 illustrates a high level flow chart of operation illustrating logical operational steps of a method 300 for accomplishing a payment transaction with respect to the customer device 210, in accordance with the disclosed embodiments. It can be appreciated that each of the steps or logical operations of the method described herein can be implemented by executing a program instruction or a group of instructions in the data-processing system 100. The instructions depicted in the disclosed embodiments can be provided by, for example, a module or group of modules, as discussed earlier herein.

One or more items can be selected by the customer 202 from the merchant's website, as illustrated at block 310. The customer ID 262 utilized by the transaction server 250 can be transmitted for requesting purchase order to the merchant 204, as depicted at block 320. The data associated with the purchase order generated by the merchant 204 such as, for example, merchant ID and total amount of purchase can be obtained and the purchase order can be transmitted to the transaction server 250, as indicated at block 330. A payment confirmation via the customer USB device 212 or an e-mail from the merchant 204 or the transaction server 250 can be received, as illustrated at block 340. The payment confirmation can also be received via a decrypted confirmation code viewed on both the customer device 210 and the merchant device 220. The selected items in the merchant website can be thereafter received from the merchant 204, as depicted at block 350. However, the customer 202 may decide to cancel a transaction if the decrypted data string displayed on the customer USB device 212 interface does not match with data associated with either the customer 202 or the merchant 204.

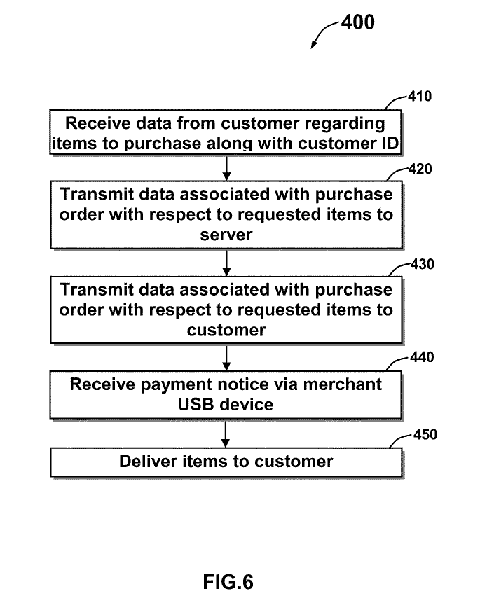

FIG. 6 illustrates a high level flow chart of operation illustrating logical operational steps of a method 400 for accomplishing a payment transaction with respect to the merchant device 220, in accordance with the disclosed embodiments. The data from the customer 202 regarding items to purchase along with the customer ID 262 can be received via the communication network 230, as illustrated at block 410. The data associated with the purchase order such as, for example, customer ID 262, total amount to be paid by the customer 202 and purchase order number can be transmitted to the transaction server 250, as depicted at block 420. The data associated with the purchase order can also be transmitted to the merchant 204, as indicated at block 430. A payment notice can be received via the merchant USB device 222 or an e-mail message from the transaction server 250, as illustrated at block 440. The items can be then delivered to the customer 202, as depicted at block 450.

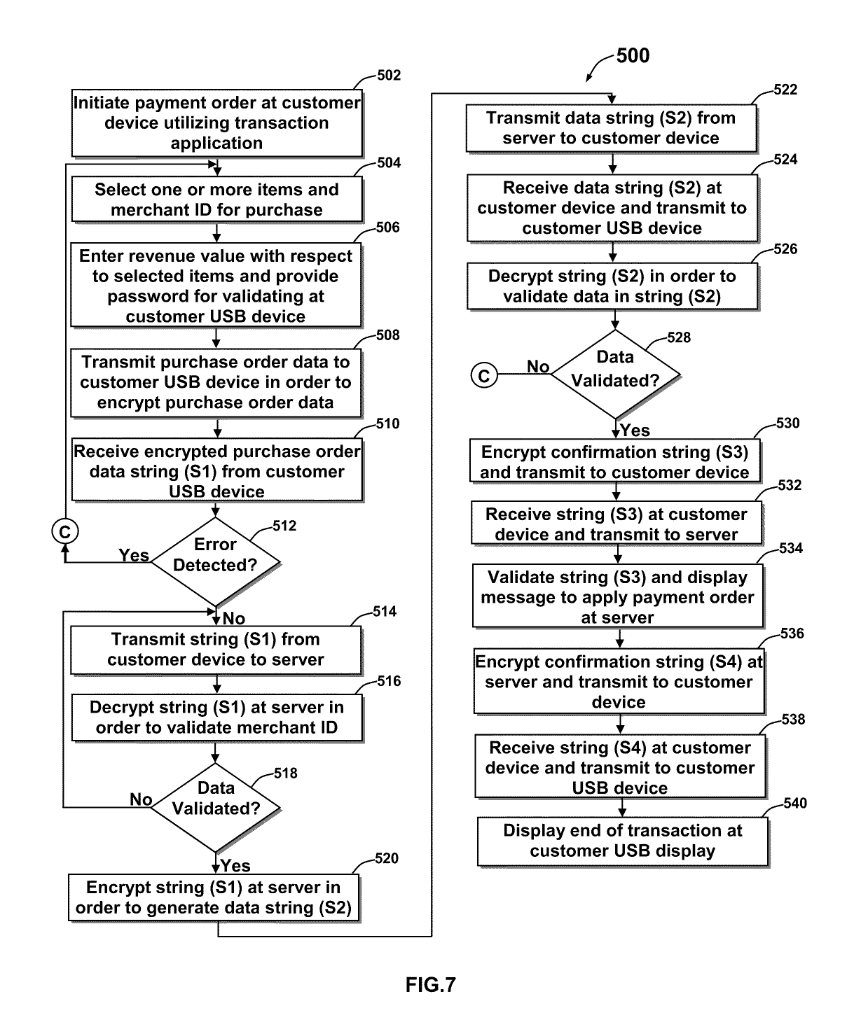

FIG. 7 illustrates a detailed flow chart of operation illustrating logical operational steps of a method 500 for accomplishing a payment order with respect to the secure string-based transaction system 200, in accordance with the disclosed embodiments. A payment order can be initiated by the customer 202 at the customer device 210 utilizing a transaction application, as illustrated at block 502. The items from the merchant website and the respective merchant ID 264 can be selected by the customer 202, as depicted at block 504. The payment service ID can be transmitted to the merchant 204 along with the payment order. On selecting the items and the merchant ID 264, the respective revenue value for the selected items can be entered and the password can be provided for validating the payment order at the customer USB device 212, as indicated at block 506. The customer USB device 212 receives this input password for authentication from the merchant 204 to communicate the authentication back to the transaction server 250.

The purchase order data can be then transmitted to the customer USB device 212 for encryption, as illustrated at block 508. The firmware application associated with the customer USB device 212 can further validate the customer's password and encrypt the customer ID 262, merchants ID 264, purchase order number and the total amount due to generate a purchase order data string (S1). Such encrypted purchase order data string (S1) can be received by the customer device 210, as depicted at block 510.

If the received string (S1) has an error, as indicated at block 512, the process can be continued from block 504. Otherwise, the data string (S1) can be transmitted from the customer device 210 to the transaction server 250, as illustrated at block 514. Thereafter, the data string (S1) can be decrypted at the transaction server 250 in order to validate the merchant ID 264, as depicted at block 516. A determination can be made whether the data is validated, as indicated at block 518. If the data is not valid, the process can be continued from the block 514. Otherwise, the data string (S1) can be encrypted at the server 250 in order to generate data string (S2), as illustrated at block 520.

Further, the data string (S2) with respect to the server 250 can be transmitted to the customer device 210, as depicted at block 522. The data string (S2) can be received at the customer device 210 and can be transmitted to the customer USB device 212, as indicated at block 524. The string (S2) can be decrypted in order to validate the data in the string (S2), as illustrated at block 526. Another determination can be made whether the data is validated, as depicted at block 528. If the data is validated, the process can be continued from the block 504. Otherwise, the confirmation data string (S3) can be encrypted and transmitted to the customer device 210, as depicted at block 530. The string (S3) can be then received at the customer device 210 and can be transmitted to the server 250, as indicated at block 532. The string (S3) can be thereof validated and a message to apply for the payment order at the server 250 can be displayed, as illustrated at block 534. The confirmation data string (S4) can be encrypted at the server 250 and transmitted to the customer device 210, as depicted at block 536. The confirmation string (S4) can be received at the customer device 210 and transmitted to the customer USB device 212, as indicated at block 538. The message indicating ‘end of transaction’ can be then displayed at the customer USB device 212, as illustrated at block 540.

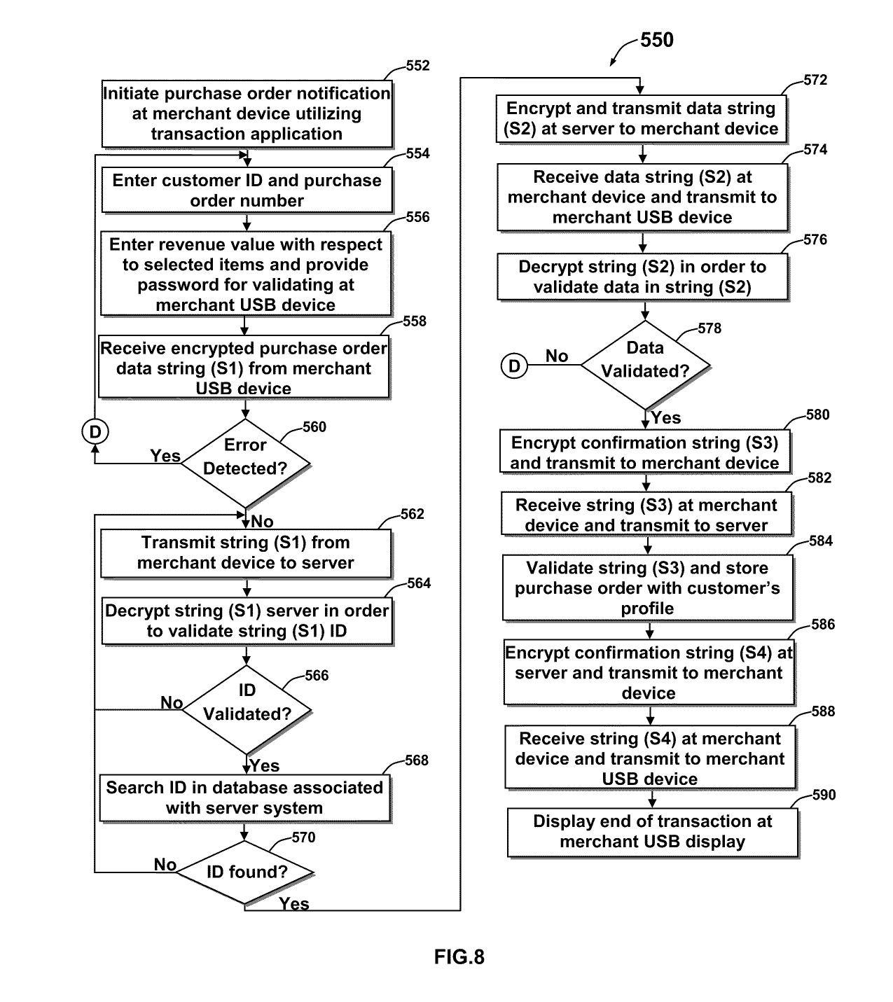

FIG. 8 illustrates a detailed flow chart of operation illustrating logical operational steps of a method 550 for accomplishing a purchase order with respect to the secure string-based transaction system 200, in accordance with the disclosed embodiments. A purchase order notification can be initiated at the merchant device 220, as illustrated at block 552. The merchant 204 can enter respective customer ID 262 and the purchase order number in order to validate the purchase transaction order at the merchant USB device 222, as depicted at block 554. The revenue value with respect to the selected items can be entered and the password for validating at the merchant USB device 222 can be provided, as indicated at block 556.

The encrypted purchase order data string can be then received from the merchant USB device 222, as illustrated at block 558. A determination can be made whether an error is detected, as depicted at block 560. If the error is detected the process can be continued from the block 554. Otherwise, the string (S1) can be transmitted from the merchant device 220 to the server 250, as indicated at block 562. The string (S1) can be decrypted at the server 250 in order to validate the string (S1), as illustrated at block 564. A determination can be made whether the customer ID 262 is validated, as depicted at block 566. If the customer ID 262 is not validated, the process can be continued from block 562. Otherwise, the customer ID 262 can be searched in the database 240 associated with the server 250, as indicated at block 568.

Therefore, a determination can be made whether the customer ID 262 is detected, as illustrated at block 570. If the customer ID 262 is not found, the process can be continued from block 562. Otherwise, the data string (S2) can be encrypted at the server 250 and transmitted to the merchant device 220, as depicted at block 572. The data string (S2) can be then received at the merchant device 220 and transmitted to the merchant USB device 222, as indicated at block 574. The string (S2) can be decrypted in order to validate data associated with string (S2), as illustrated at block 576. Thereafter, a determination can be made whether the data is valid, as illustrated at block 578. If the data is not valid, the process can be continued from the block 554.

Otherwise, the confirmation string (S3) can be encrypted and transmitted to the merchant device 220, as depicted at block 580. The string (S3) can be thereafter received at the merchant device 220 and transmitted to the server 250, as indicated at block 582. The string (S3) can be validated and the purchase order with customer's profile can be stored, as illustrated at block 584. The confirmation string (S4) at the server 250 can be then encrypted and transmitted to the merchant device 220, as depicted at block 586. The string (S4) can be received at the merchant device 220 and transmitted to the merchant USB device 222, as indicated at block 638. Finally, the message indicating ‘end of transaction’ can be displayed at the merchant USB display 242, as illustrated at block 590.

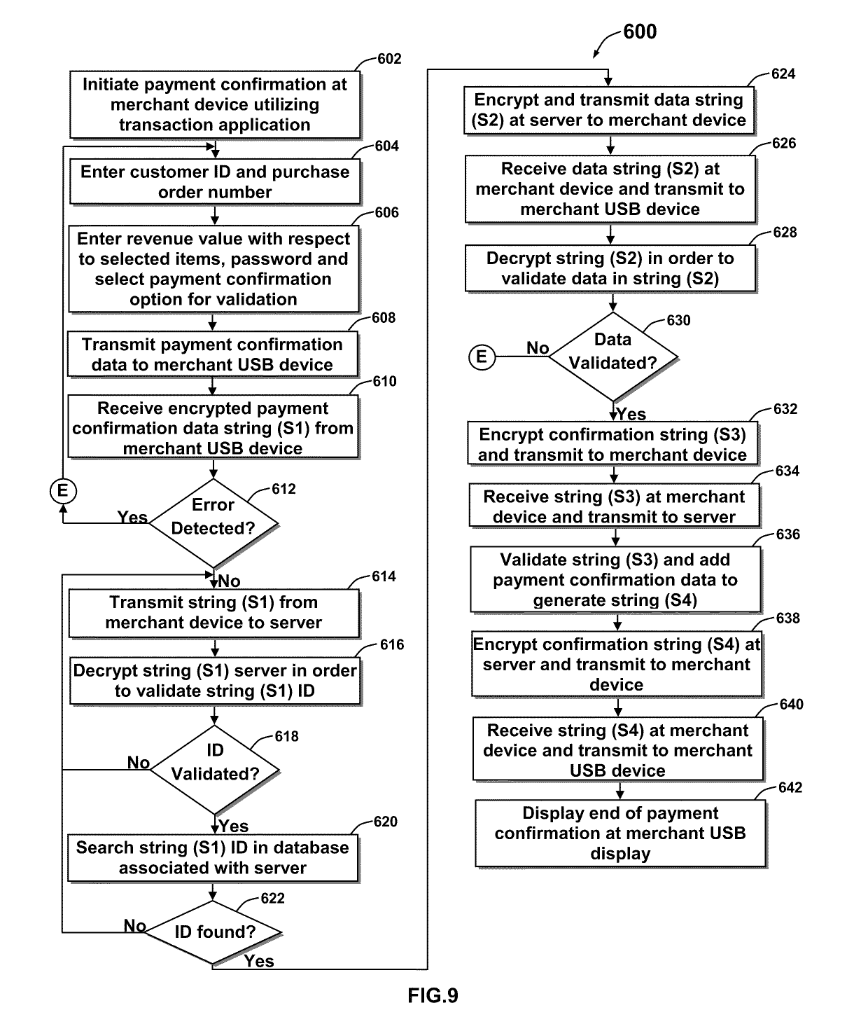

FIG. 9 illustrates a detailed flow chart of operation illustrating logical operational steps of a method 600 for accomplishing a payment confirmation with respect to the secure string-based transaction system 200, in accordance with the disclosed embodiments. A payment confirmation process can be initiated at the merchant device 220 utilizing the transaction application, as illustrated at block 602. The customer ID 262 and the purchase order can be entered, as depicted at block 604. The revenue value with respect to the selected items can be entered and the payment confirmation option for validation can be selected, as indicated at block 606. The payment confirmation data can be transmitted to the merchant USB device 222, as illustrated at block 608. The encrypted payment confirmation data string (S1) can be received from the merchant USB device 222, as depicted at block 610. A determination can be made whether an error is detected, as indicated at block 612. If the error is detected, the process can be continued from block 604. Otherwise, the string (S1) can be transmitted from the merchant device 220 to the server 250, as illustrated at block 614. The string (S1) can be then decrypted from the server 250 in order to validate string (S1) ID, as depicted at block 616.

Further, a determination can be made whether the string (S1) ID is valid, as indicated at block 618. If the string (S1) ID is not valid the process can be continued from the block 614. Otherwise, the string (S1) ID can be searched in the database 240 associated with the server 250, as illustrated at block 620. Another determination can be made whether the string (S1) ID is found, as depicted at block 622. If the string (S1) ID is not found, the process can be continued from the block 614. Otherwise, the data string (S2) can be encrypted at the server 250 and transmitted to the merchant device 220, as indicated at block 624. The data string (S2) can be then received at the merchant device 220 and transmitted to the merchant USB device 222, as illustrated at block 626. The string (S2) can be decrypted in order to validate the data associated with string (S2), as depicted at block 628.

Thereafter, another determination can be made whether the data is valid, as indicated at block 630. If the data is not valid, the process can be continued from block 604. Otherwise, the confirmation string (S3) can be encrypted and transmitted to the merchant device 220, as illustrated at block 632. The string (S3) can be then received at the merchant device 220 and transmitted to the server 250, as depicted at block 634. The string (S3) can be thereof validated and the payment confirmation data can be added to generate the data string (S4), as indicated at block 636. The confirmation string (S4) can be encrypted at the server 250 and transmitted to the merchant device 220, as illustrated at block 638. The string (S4) can be then received at the merchant device 220 and transmitted to the merchant USB device 222, as depicted at block 640. The message indicating ‘end of payment confirmation’ can be displayed at the merchant USB display 242, as shown at block 642.

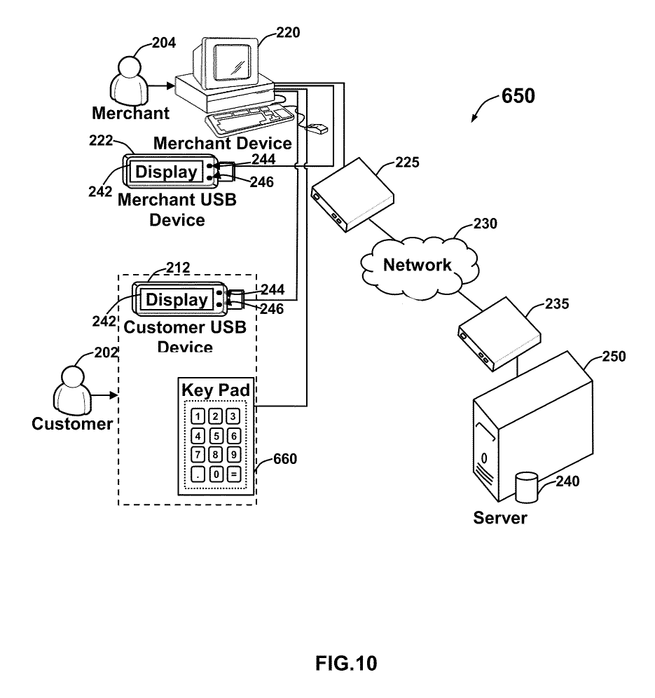

FIG. 10 illustrates a graphical representation of the secure string-based transaction system 650 associated with a merchant device 220 for communicating the merchant 204 and the customer 202 over the network 230, in accordance with the disclosed embodiments. The system 650 includes the merchant device 220 that can be accessed by the customer 202 and the merchant 204 for transacting over the network 230. The merchant device 220 includes the merchant USB device 222 that can be employed to encrypt/decrypt the data strings transmitted/received by the merchant 204. Similarly, the merchant device 220 includes the customer USB device 212 that can be employed to encrypt/decrypt the data strings transmitted/received by the customer 202. The merchant program associated with the merchant device 220 can perform the task required for the customer 202 and the merchant 204. The customer 202 can input the password via a keypad 660 provided by the merchant 204. The data required by the customer USB device 212 can be transmitted via the merchant device 220 in such a way that the customer 202 can verify, the merchant's ID 264 and the total amount to be paid in the USB device 212. The merchant device 220 may also provide the customer device 210 with an input password for authentication to communicate the authentication with the transaction server 250.

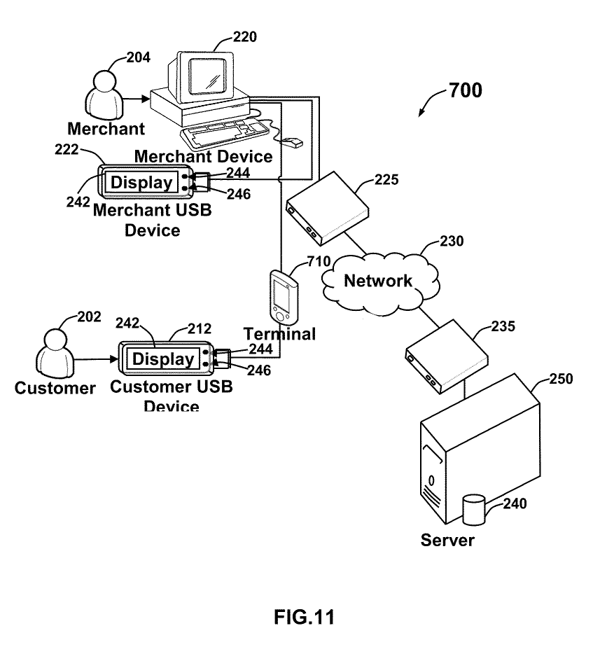

FIG. 11 illustrates a graphical representation of the secure string-based transaction system 700 associated with a terminal 710 for communicating the customer USB device 212, in accordance with the disclosed embodiments. The system 700 includes the merchant device 220 that can be accessed by the merchant 204 and the customer 202 for transacting over the network 230. The merchant device 220 can be configured with the merchant USB device 222 for providing access to the merchant 204. The data required by the customer USB device 212 can be transmitted via the terminal 710 which can be employed as an interface between the merchant device 220 and the USB device 212. The customer 202 can input the password via the integrated terminal's keypad. The terminal 710 can be a wireless terminal and can communicate with the merchant device 220 via wired or wireless transaction service application techniques, such as USB, Serial, LAN, WLAN, WiMax, RF, BT, IrDA, VFIR, WiFi and or UWB communication techniques.

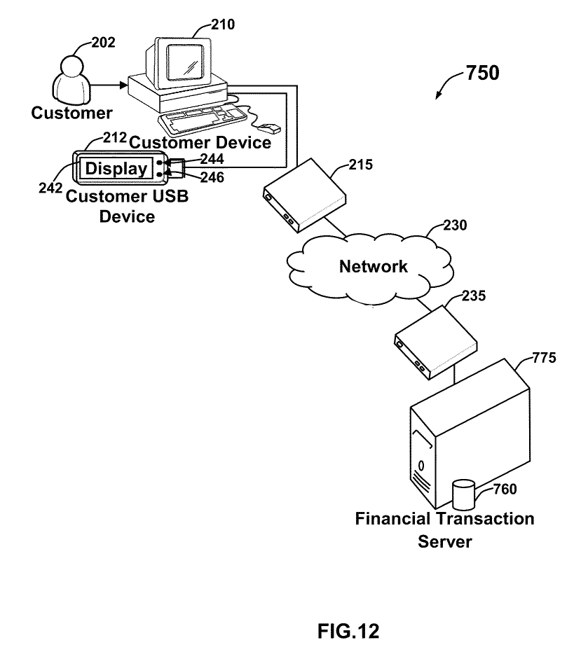

FIG. 12 illustrates a graphical representation of a secure string-based transaction system 750 utilized in context of a financial institution, in accordance with the disclosed embodiments. Again as a reminder, note that in FIGS. 1-16, identical or similar blocks are generally indicated by identical reference numerals. The secure string-based transaction system 750 can be employed to accomplish an account-to-account transaction between the customer 202 and the financial institution. The system 750 generally includes the customer device 210 that is configured in association with the customer USB device 212. The customer device 210 can be further configured in associated with an Internet financial transaction server 775 via the communication network 230.

The financial transaction server 775 can be preferably placed behind several different firewalls, through which it communicates with the authorized customer device 220 in the network 230. The customer 202 can access a financial institution website from the client device 220 utilizing standard network application, such as, for example, Internet Explorer, Firefox or any other browser. The customer 202 can provide user ID and password in order to access the transaction page associated with the financial institution website. When the customer 202 activates the website, the customer 202 can be directed to the Internet transaction server 775 for authentication. The server 775 can authenticate the user ID and password utilizing the stored customer information in the database 760 and thereby provide secured transactions within the network 230.

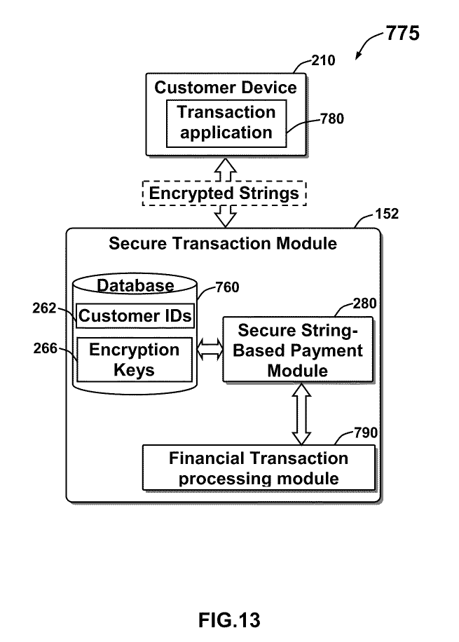

FIG. 13 illustrates a block diagram of the financial transaction server 775, in accordance with the disclosed embodiments. The Internet transaction module 152 associated with the financial transaction server 775 includes the secure string-based payment module 280, a financial transaction processing module 790 and a database 760. The Internet transaction module 152 provides secured financial transactions between the customer 202 and the financial institution over the network 230. The customer device 210 can include a transaction application 780 to access the financial transaction server 775. The financial transaction server 775 can receive/transmit encrypted strings in order to validate and verify the customer 202. The database 760 associate with the server 775 stores the customer information such as, customer ID's 262 and encryption keys 266 within the server 775. The secure string-based payment module 280 can access the database 760 in order to authenticate the customer 202 accessing the financial transaction server 775. Upon authenticating the customer 202, the financial transaction processing module 790 can further initiate the financial transactions process between the server 775 and the customer device 210.

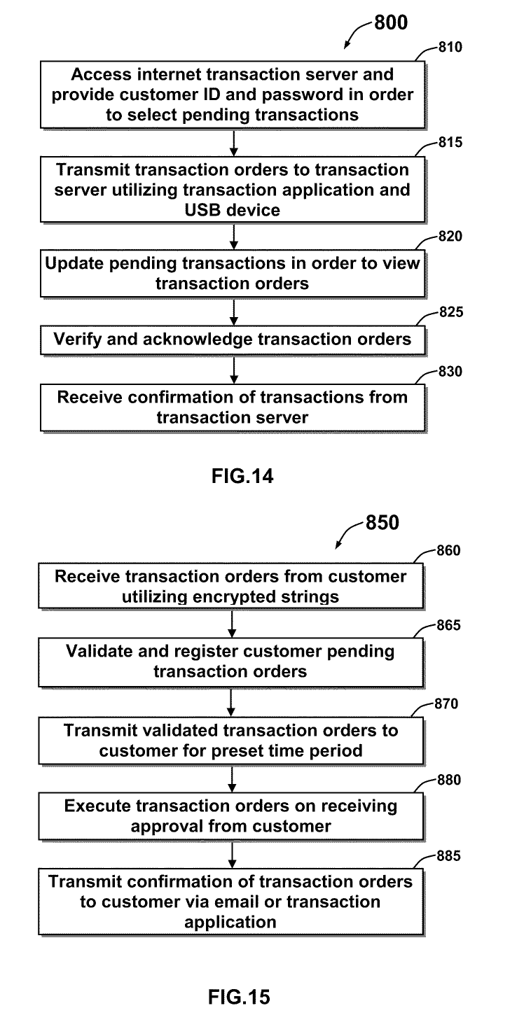

FIG. 14 illustrates a high level flow chart of operation illustrating logical operation steps of a method 800 for accomplishing an account to account transaction with respect to the customer device 210, in accordance with the disclosed embodiments. The financial institution website can be accessed and the customer ID 262 and password can be provided by the customer 202 in order to select pending transaction with respect to the customer 202, as illustrated at block 810. The pending transactions can be selected and transmitted to the financial server 775 via the customer USB device 212, as depicted at block 815. Further, the pending transactions in the website can be updated by the customer 202 in order to view transaction orders with respect to the financial transaction server 775, as indicated at block 820. The transaction order can be verified and acknowledged by the customer via the customer device 210 and the customer USB device 212, as illustrated at block 825. The confirmation for the transactions can be received from the financial transaction server 775, as indicated at block 830.

FIG. 15 illustrates a high level flow chart of operation illustrating logical operation steps of a method 850 for accomplishing an account-to-account transaction with respect to the financial transaction server 775, in accordance with the disclosed embodiments. The transaction orders can be received from the customer utilizing the encrypted strings, as illustrated at block 860. The pending transaction orders at the server 775 can be validated and registered, as depicted at block 865. The validation of transaction orders with respect to the customer 202 can be performed by utilizing the customer information stored in the database 760 associated with the financial transaction server 775. The validated transaction orders can be transmitted to the customer 202 for a preset period of time, as illustrated at block 870. The server 775 can wait for approval from the customer 202 for the preset time period. Upon receiving the approval from the customer 202, the server 775 can execute the transaction order via the financial transaction processing module 790, as depicted at block 880. A confirmation regarding the transaction orders can be transmitted to the customer 202 via e-mail or financial institution website, as illustrated at block 885.

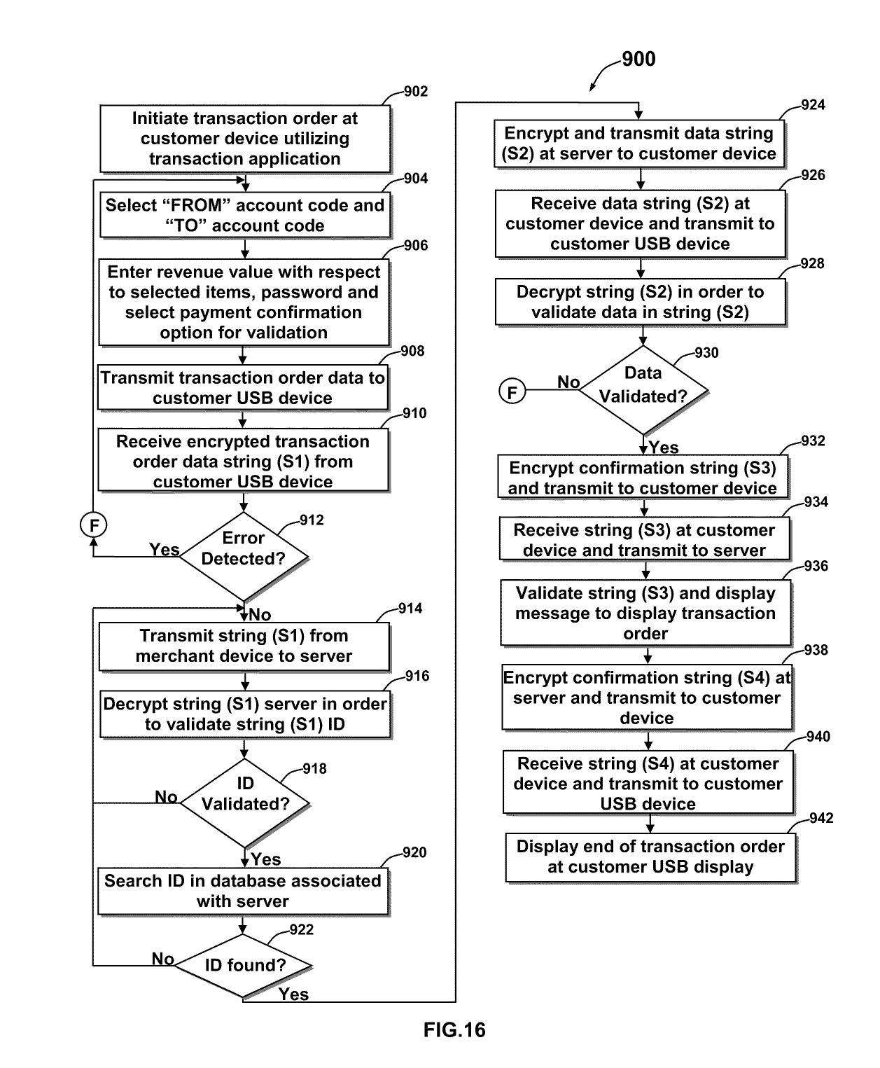

FIG. 16 illustrates a detailed flow chart of operation illustrating logical operation steps of a method 900 for providing an account-to-account transaction in context of the financial institution, in accordance with the disclosed embodiments. The transaction order with respect to the customer 202 can be initiated and the username and password can be provided with respect to the financial institution website utilizing the customer device 210, as illustrated at block 902. A “FROM” account code and a “TO” account code with respect to the transaction order can be selected by the customer 202, as depicted at block 904. The revenue value and password can be provided and a payment confirmation option can be for validating the transaction order at the customer USB device 212, as depicted at block 906. The transaction order with respect to the customer device 210 can be transmitted to the customer USB device 212, as illustrated at block 908.

Further, the customer password can be validated via the firmware application associated with the customer USB device 212 and an encrypted string (S1) containing the “source and receiving account codes” and total amount to be transferred can be generated in the customer USB device 212. The string (S1) can be transmitted to the display associated with the customer USB device 212 in order to facilitate the customer 202 to check the data received with respect to the customer USB device 212. If the transaction order data received at the customer USB device 212 is correct, the customer 202 can press the “select” button 244 in order to choose the send option displayed by the firmware application and then the “enter” button 246 to send string (S1) and initiate the transaction process. The encrypted string (S1) with respect to the transaction order can be then received from the customer USB device, as illustrated at block 910.

A determination can be then made whether an error is detected, as indicated at block 912. If the error is detected, the process can be continued from the block 904. Otherwise, the string (S1) can be transmitted from the customer device 210 to the server 775, as illustrated block 914. The string (S1) can be decrypted in order to validate string (S1) ID, as depicted at block 916. Further, a determination can be made whether the string (S1) ID is validated, as shown at block 918. If the string (S1) ID is not validated the process can be continued from the block 914.

Otherwise, the string (S1) ID can be searched in the database 760 associated with the server 775, as illustrated at block 920. Another determination can be made whether the string (S1) ID is found, as depicted at block 922. If the string (S1) ID is not found, the process can be continued from the block 914. Otherwise, the data string (S2) can be encrypted at the server 775 and transmitted to the customer device 210, as shown at block 924. The data string (S2) can be then received at the customer device 220 and transmitted to customer USB device 212, as illustrated at block 926. The string (S2) can be decrypted in order to validate the data in string (S2), as depicted at block 928.

A determination can be then made whether the data is validated, as indicated at block 930. If the data is not validated, the process can be continued from the block 904. Otherwise, the confirmation string (S3) can be encrypted and transmitted to the customer device 210, as illustrated at block 932. The string (S3) can be received at the customer device 210 and transmitted to the server 775, as depicted at block 934. The string (S3) can be validated and a message can be displayed, as depicted at block 936. The confirmation string (S4) can be encrypted at server 775 and transmitted to the customer device 210, as illustrated at block 938.

The string (S4) can be then received at the customer device 210 and transmitted to the customer USB device 212, as depicted at block 940. Such confirmation string (S4) can be utilized to notify the customer's USB Device 212 that the confirmation string (S3) is received and passed the test of the server application. The string (S4) can be decrypted and validated at the customer USB device 212 and if the string (S4) passes the test in the customer USB device 212, then a signal can be displayed in the customer USB Device 212. For example an LED can be lighted on the message indicating ‘end of transaction order’ can be displayed at the customer USB display 242, as depicted at block 942.

The client device can be connected to the transaction server via a HTML protocol and Winsock connection, which secures the transactions from spoofing and phishing. Such a configuration secures the transaction information from varying spyware and malware applications and fraudulent transactions and virus transfers over the network. The secure string-based transaction system and method disclosed herein can be effectively employed in various web-based transaction applications such as, PayPal, e-banking and on-line business transaction applications in order to provide secured transactions between the clients. While the present invention has been described with reference to payment requests and transaction in an electronic commerce system, these requests and transactions are considered to be general constructs covering other, non-payment systems and transactions.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A secure transaction system, said system comprising:
at least one client device for transmitting and receiving a secure transaction data string with respect to a transaction process over a communication network;
an encryption device including a microcontroller configured in association with said at least one client device in order to encrypt, decrypt and validate said transaction data string based on a string based encryption algorithm; and
a transaction server associated with a database for storing said transaction data string and a transaction service application for encrypting, decrypting and validating said transaction data string in order to provide a comprehensively secure transaction over said communication network.

2. The system of claim 1 further comprising a firmware application configured in association with said encryption device to encrypt and decrypt said transaction data string associated with said at least one client device.

3. The system of claim 1 wherein said encryption device comprises a USB device.

4. The system of claim 3 wherein said USB device further comprises:
a USB interface for interfacing said at least one client device; and
a display, a select button and an enter button for displaying said transaction data string transmitted and received as decrypted string data via said at least one client device.

5. The system of claim 1 wherein said at least one client device comprises a customer device associated with a customer encryption device.

6. The system of claim 1 wherein said at least one client device comprises a merchant device associated with a merchant encryption device.

7. The system of claim 6 further comprising a terminal for interfacing said customer encryption device with said merchant device.

8. The system of claim 6 further comprising a keypad for communicating said transaction data string from said customer encryption device to said merchant device.

9. The system of claim 1 wherein said transaction data string comprises a restricted range of ASCII decimal values to filter malware.

10. The system of claim 1 wherein said communication network comprises an Internet.

11. The system of claim 1 wherein said secure transaction data string comprises at least one of the following types of data:
a client ID;
a total amount to be paid;
a purchase order number; or
an encryption key.

12. A method for providing a secure transaction, comprising:
transmitting a secure transaction data string with respect to a transaction process from at least one client device to an encryption device in order to thereafter encrypt and transmit said transaction data string to a transaction server via a communication network;
decrypting and validating said transaction data string from said at least one client device in order to thereafter provide a validated encrypted data string for approval to said at least one client device; and
providing a confirmation string from said at least one client device to said server in order to thereafter decrypt, validate and approve said transaction data string and transmit a receipt of confirmation to said at least one client device thereby providing a secure transaction over said communication network.

13. The method of claim 12 further comprising retaining said transaction data string as a random code with respect to a previous transaction on a database associated with said transaction server to prevent cloning of said encryption device.

14. The method of claim 12 wherein said encryption device comprises a USB device.

15. The method of claim 14 further comprising:
interfacing said at least one client device via a USB interface; and
displaying said transaction data string transmitted and received via said at least one client device as decrypted string data on a display associated with said USB device.

16. The method of claim 14 further comprising cancelling a transaction if said decrypted string data displayed on said USB interface does not match with data associated with said client.

17. The method of claim 12 wherein said at least one client device further comprises configuring a customer device in association with a customer encryption device.

18. The method of claim 12 wherein said at least one client device further comprises configuring a merchant device in association with a merchant encryption device.

19. The method of claim 17 further comprising configuring said customer device to receive an input password from said merchant device to communicate with said transaction server.

20. The method of claim 12 further comprising receiving said receipt of confirmation from said transaction server via a decrypted confirmation code viewed on said at least one client device.
